(19) United States
(12) Patent Application Publication
(10) Pub. No.: US 2022/0269938 A1
(43) Pub. Date: Aug. 25, 2022

(54) PRESENTING THOUGHT-PROVOKING QUESTIONS AND ANSWERS IN RESPONSE TO MISINFORMATION

(71) Applicant: International Business Machines Corporation, Armonk, NY (US)

(72) Inventors: Nicholas Linck, San Jose, CA (US); Mu Qiao, Belmont, CA (US); Yuya Jeremy Ong, San Jose, CA (US); Marisa Affonso Vasconcelos, Sao Paulo (BR); Claudio Santos Pinhanez, Sao Paulo (BR); Rogerio Abreu de Paula, Sao Paulo (BR)

(21) Appl. No.: 17/184,668

(22) Filed: Feb. 25, 2021

(51) Int. Cl. G06N 3/08; G06N 3/04; G06F 16/2457; G06F 40/20

(52) U.S. Cl. CPC G06N 3/08; G06N 3/0445; G06N 3/0454; G06F 16/24575; G06F 40/20; G06F 3/14

(57) ABSTRACT

To reduce misinformation consumption in the media, a computer-implemented method is described for presenting thought-provoking information about a media product that includes receiving media consumption data indicating a media product was consumed via a computing device user interface; determining claims for the media product; identifying a plurality of related media products based at least on a topic of the media product; determining positions for the plurality of related media products with respect to the one or more claims; determining a most contested claim as a claim that satisfies a condition corresponding to having a predetermined number of disagreeing related media products; generating a question based on the most contested claim and a paragraph including the most contested claim; generating an answer to the question based on the question and the related media product that disagrees with the most contested claim; and presenting the question and answer via the user interface.

### BACKGROUND

The present invention relates generally to the field of electronic information distribution, and more particularly to presenting thought-provoking information in response to misinformation.

Misinformation, false information, otherwise known in social media and news outlets as “fake news” has been on a trending topic with the rise of social media. Fake news is false or misleading information presented as news. Misinformation is false or inaccurate information that is communicated regardless of an intention to deceive. Disinformation is a species of misinformation that is deliberately deceptive (e.g., malicious hoaxes, spear phishing, and computational propaganda). Disinformation often has the aim of damaging the reputation of a person or entity, or making money through advertising revenue. Sharing content on social media platforms is powerful enough to disrupt governments and profitable enough to merit significant investments. The emotional response to media consumption can vary across the spectrum, but the more triggering the story, the more likely it will be shared within user networks. Fake news generally targets emotions, causing users to more readily share this information.

Confirmation bias occurs when people are inclined to embrace information that supports their beliefs and reject information that contradicts those beliefs. Confirmation bias leads people to dismiss evidence of new or underappreciated threats.

When forming an opinion on a particular issue or topic, using intuitive judgment is actually the last thing people want to be doing if critical thinking is their goal. Gut instincts—experienced as perceptions or feelings—generally leads the thinker to favor perspectives consistent with their own personal biases and experiences or those of their group. Lack of knowledge and willingness, misunderstanding the truth, and closemindedness all contribute to idle minds believing misinformation.

A fundamental component in argument modeling is the concept of a claim (or conclusion). Specifically, at the heart of every argument lies a single claim, which is the assertion the argument aims to prove. Given a concrete topic or context, most people will find it challenging to swiftly raise a diverse set of convincing and related claims that should set the basis of their arguments. A claim is a conclusion of a topic, framed within a defined context, whose merit must be established. A topic is a short phrase that frames the discussion and a context dependent claim is a general, concise statement that directly supports or contests the given topic. Context Dependent Claim Detection (CDCD) is helpful in decision support and persuasion enhancement and is a sub-task in the argumentation mining field involving identifying argumentative structures within a document. CDCD is defined with respect to a given context, which is the input topic. CDCD requires pinpointing the exact claim boundaries, which do not necessarily match a whole sentence or even a clause in the original text, thus adding a significant burden to the task, compared to classical tasks that are focused on sentence classifications.

### SUMMARY

Embodiments of the present invention disclose a computer-implemented method, a computer program product, and a system for presenting thought-provoking information about a media product. The computer-implemented method may include one or more processors configured for receiving media consumption data indicating a media product having one or more sentences was consumed via a user interface of a computing device; determining one or more claims for the media product using a first machine learning model; identifying a plurality of related media products having respective one or more related sentences based at least on a topic of the media product. The topic of the media product may be determined by processing, using a trained classifier, the one or more sentences of the media product to identify text corresponding to a title; and identifying the title as the topic. Identifying the plurality of related media products may further include processing, by a media collection program, input data corresponding to the topic of the media product; and generating, by the media collection program, a list of the plurality of media products in order of most related to least related, wherein the media collection program is configured to search a database of media products and return a list of related media products corresponding to the input data provided to the media collection program.

In an embodiment, the first machine learning model may include a binary classifier and determining the one or more claims may further include the one or more processors configured for training the binary classifier using a first labeled data set; processing, by the binary classifier, the media product having one or more sentences; and outputting, by the binary classifier, ranked sets of sentences for the media product, wherein the ranked sets of sentences may correspond to the one or more sentences and are ranked based on a likelihood to contain the one or more claims.

In another embodiment, the first machine learning model may include a binary classifier and determining the one or more related claims may further include the one or more processors configured for training the binary classifier using a first labeled data set; processing, by the binary classifier, the plurality of related media products having respective one or more related sentences; and outputting, by the binary classifier, ranked sets of sentences for each one of the plurality of related media products, wherein the ranked sets of sentences corresponds to the one or more related sentences and are ranked based on a likelihood to contain the one or more related claims.

The computer-implemented method may further include one or more processors configured for determining one or more related claims for at least one of the plurality of related media products using the first machine learning model; determining a most contested claim of the one or more claims for the media product as a claim that satisfies a condition corresponding to having a predetermined number of the plurality of related media products in disagreement with the claim. The most contested claim may also be determined by identifying which claim has the most related media products with a position corresponding to a disagree stance.

In an embodiment, the computer-implemented method may further include one or more processors configured for generating a question based on the most contested claim and a paragraph including the most contested claim; generating an answer to the question based at least on the question and at least one of the related media products having a disagree position with the most contested claim; and presenting one or more of the question and the answer via the user interface of the computing device.

In an embodiment, the computer-implemented method may further include the one or more processors configured for determining positions for each one of the plurality of related media products with respect to each of the one or more claims for the media product using the second machine learning model. The positions may include the disagree position, an agree position, a neutral (or no position) position, and an unrelated position.

In an embodiment, determining the most contested claim may further include the one or more processors configured for processing, at a second machine learning model, the one or more claims and at least one of the plurality of related media products; outputting, by the second machine learning model, a position (e.g., classification) for each one of the plurality of related media products, wherein the position may correspond to a relationship between the one or more claims and each one of the plurality of related media products; and identifying the most contested claim as the claim of the one or more claims with a most negative relationship with the plurality of related media products. For example, the most contested claim may be a claim that has the most related media products with a disagree stance.

In an embodiment, the computer-implemented method for generating the question may further include the one or more processors configured for processing, at a third machine learning model, the most contested claim and the paragraph including the most contested claim using bidirectional long-short term memory (LSTM) to generate LSTM encoder output data; concatenating, by the third machine learning model, the LSTM encoder output data to generate LSTM decoder input data; and processing, by the third machine learning model, the LSTM decoder input data and a context vector to generate question data corresponding to the question, wherein the context vector is the sum of a weighted average of encoder hidden states. The third machine learning model may include a conditional neural language model configured to generate text at least based on determining a probability distribution over a sequence of words, estimating the conditional probability of the next word in a sequence or generating new text.

In an embodiment, generating the answer may further include the one or more processors configured for processing, at a fourth machine learning model, the question and the related media product that disagrees with the most contested claim to extract evidence snippets using a bidirectional recurrent neural network (RNN); and processing, by the fourth machine learning model, the evidence snippets, the question and the related media product that disagrees with the most contested claim to generate answer data corresponding to the answer. The question and the answer may be presented via the user interface during a time frame to allow a user to perceive the question along with the answer.

### BRIEF DESCRIPTION OF THE DRAWINGS

FIG. 1 depicts a block diagram of a distributed data processing environment for presenting thought-provoking information about a media product, in accordance with an embodiment of the present invention;

FIG. 2 depicts a block diagram of a computer-implemented process for presenting thought-provoking information about a media product, in accordance with an embodiment of the present invention;

FIG. 3 depicts a chart for presenting thought-provoking information about a media product, in accordance with an embodiment of the present invention;

FIG. 4A depicts a block diagram of a machine learning model for classifying a position of a related media product, in accordance with an embodiment of the present invention;

FIG. 4B depicts a block diagram of another machine learning model for generating a question, in accordance with an embodiment of the present invention;

FIG. 5 depicts a block diagram of a recurrent neural network (RNN) model for generating an answer, in accordance with an embodiment of the present invention;

FIG. 6 depicts a flow chart of steps of a computer-implemented method for presenting thought-provoking information in response to misinformation, in accordance with an embodiment of the present invention; and

FIG. 7 depicts a block diagram of components of the server computer executing the computer-implemented method for presenting thought-provoking information about a media product within the distributed data processing environment of FIG. 1, in accordance with an embodiment of the present invention.

### DETAILED DESCRIPTION

In order to combat users' belief in misinformation, methods must be deployed to step in at the moment the false information is being consumed by the user. Embodiments of the present invention recognize that an opportunity exists to trigger users' critical thinking to prevent misinformation from being believed by individuals who have already consumed it. Once a user has read an article containing misinformation, the embodiments described herein aim to ensure that the user does not end up believing the false information that they have consumed (e.g., read or listened to). Users must engage in critical thinking in order to avoid blindly trusting information they have consumed. Embodiments of this invention aim to tackle three barriers that result in individuals not engaging in critical thinking: lack of knowledge, lack of willingness to seek information, and lack of attention. Therefore, embodiments of the present invention provide computer-implemented methods, computer program products, and computer systems configured for presenting thought-provoking information about a media product, wherein the presented information is configured for provoking analytical thinking in response to a media product with misinformation. Implementation of embodiments of the invention may take a variety of forms, and exemplary implementation details are discussed subsequently with reference to the Figures.

The present invention therefore provides a computer-implemented method for presenting thought-provoking information about a media product, the computer-implemented method comprising receiving media consumption data indicating a media product having one or more sentences was consumed via a user interface of a computing device; determining one or more claims for the media product using a first machine learning model; identifying a plurality of related media products having respective one or more related sentences based at least on a topic, title, summary text, or topical information of the media product. The title, summary text, or topical information of the media product may be determined by processing, using a trained classifier, the one or more sentences of the media product to identify text corresponding to the title, summary text, or topical information. Identifying the plurality of related media products may further include processing, by a media collection program, input data corresponding to the topic of the media product; and generating, by the media collection program, a list of the plurality of media products in order of most related to least related, wherein the media collection program is configured to search a database of media products and return a list of related media products corresponding to the input data provided to the media collection program.

The first machine learning model may include a binary classifier, and determining the one or more claims may further include training the binary classifier using a first labeled data set; processing, by the binary classifier, the media product having one or more sentences; and outputting, by the binary classifier, ranked sets of sentences for the media product, wherein the ranked sets of sentences may correspond to the one or more sentences and are ranked based on a likelihood to contain the one or more claims.

In another embodiment, the first machine learning model may include a binary classifier and determining the one or more related claims may further include training the binary classifier using a first labeled data set; processing, by the binary classifier, the plurality of related media products having respective one or more related sentences; and outputting, by the binary classifier, ranked sets of sentences for each one of the plurality of related media products, wherein the ranked sets of sentences corresponds to the one or more related sentences and are ranked based on a likelihood to contain the one or more related claims.

The computer-implemented method may further include determining positions for each one of the plurality of related media products with respect to each of the one or more claims of the media product for the plurality of related media products in disagreement with the claim using a second machine learning model; determining a most contested claim of the one or more claims of the media product as a claim that satisfies a condition corresponding to having a predetermined number of the plurality of related media products in disagreement with the claim; generating a question based on the most contested claim and a paragraph including the most contested claim; generating an answer to the question based at least on the question and at least one of the related media products having a disagree position with the most contested claim; and presenting one or more of the question and the answer via the user interface of the computing device.

In an embodiment, determining the most contested claim may further include processing, at a second machine learning model, the one or more claims and at least one of the plurality of related media products; outputting, by the second machine learning model, a position for each one of the plurality of related media products, wherein the position may correspond to a relationship between the one or more claims and each one of the plurality of related media products; and identifying the most contested claim as the claim of the one or more claims with a most negative relationship with the plurality of related media products. For example, the most contested claim may be the claim which has the most related media products with a disagree stance or position.

In an embodiment, generating the question may further include processing, at a third machine learning model, the most contested claim and the paragraph including the most contested claim using bidirectional long short term memory (LSTM) to generate LSTM encoder output data; concatenating, by the third machine learning model, the LSTM encoder output data to generate LSTM decoder input data; and processing, by the third machine learning model, the LSTM decoder input data and a context vector to generate question data corresponding to the question, wherein the context vector is the sum of a weighted average of encoder hidden states.

In an embodiment, generating the answer may further include processing, at a fourth machine learning model, the question and the related media product that disagrees with the most contested claim to extract evidence snippets using a bidirectional recurrent neural network (RNN); and processing, by the fourth machine learning model, the evidence snippets, the question and the related media product that disagrees with the most contested claim to generate answer data corresponding to the answer. The question and the answer may be presented via the user interface during a time frame to allow a user to perceive the question along with the answer.

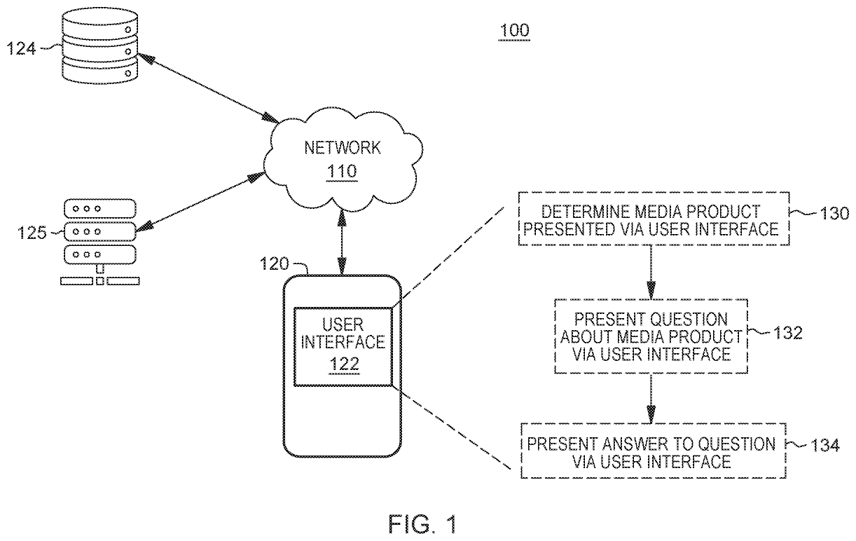

FIG. 1 depicts a block diagram of a distributed data processing environment 100 for presenting thought-provoking information about a media product, in accordance with an embodiment of the present invention. FIG. 1 provides only an illustration of one embodiment of the present invention and does not imply any limitations with regard to the environments in which different embodiments may be implemented. The term “distributed” as used herein describes a computer system that includes multiple, physically distinct devices that operate together as a single computer system. Many modifications to the depicted environment may be made by those skilled in the art without departing from the scope of the invention as recited by the claims.

In the depicted embodiment, distributed data processing environment 100 includes computing device 120 with user interface 122, server 125, and database 124 interconnected over network 110. Network 110 operates as a computing network that can be, for example, a local area network (LAN), a wide area network (WAN), or a combination of the two, and can include wired, wireless, or fiber optic connections. In general, network 110 can be any combination of connections and protocols that will support communications between computing device 120, server 125, and database 124. Distributed data processing environment 100 may also include additional servers, computers, sensors, or other devices not shown.

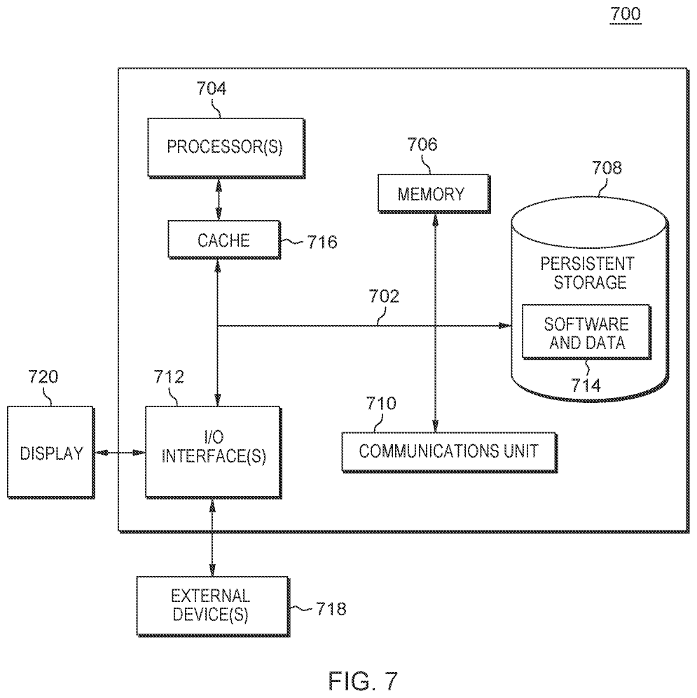

Computing device 120 operates to execute at least a part of a computer program for presenting thought-provoking information about a media product. In an embodiment, computing device 120 may be communicatively coupled with user interface 122 or user interface 122 may be one of computing device 120 components. Computing device 120 may be configured to send and/or receive data from network 110 and user interface 122. In some embodiments, computing device 120 may be a management server, a web server, or any other electronic device or computing system capable of receiving and sending data. In some embodiments, computing device 120 may be a laptop computer, tablet computer, netbook computer, personal computer (PC), a desktop computer, a smart phone, or any programmable electronic device capable of communicating with database(s) 124, server(s) 125 via network 110. Computing device 120 may include components as described in further detail in FIG. 7.

Database 124 operates as a repository for data flowing to and from network 110. Examples of data include user data, device data, network data, and data corresponding to information processed by computing device 120 and presented by user interface 122. A database is an organized collection of data. Database 124 can be implemented with any type of storage device capable of storing data and configuration files that can be accessed and utilized by computing device 120, such as a database server, a hard disk drive, or a flash memory. In an embodiment, database 124 is accessed by computing device 120 to store data corresponding to information processed by computing device 120 and presented by user interface 122. In another embodiment, database 124 is accessed by computing device 120 to access user data, device data, network data, and data corresponding to information processed by computing device 120 and presented by user interface 122. In another embodiment, database 124 may reside elsewhere within distributed network environment 100 provided database 124 has access to network 110.

Server 125 can be a standalone computing device, a management server, a web server, or any other electronic device or computing system capable of receiving, sending, and processing data and capable of communicating with computing device 120 via network 110. In other embodiments, server 125 represents a server computing system utilizing multiple computers as a server system, such as a cloud computing environment. In yet other embodiments, server 125 represents a computing system utilizing clustered computers and components (e.g., database server computers, application server computers, etc.) that act as a single pool of seamless resources when accessed within distributed data processing environment 100. Server 125 may include components as described in further detail in FIG. 7.

In an embodiment, one or more processors may be configured to determine 130 that a media product was presented via user interface 122, wherein the media product is, e.g., a news article, and user interface 122 is part of computing device 120 associated with a user. The one or more processors may also be configured to determine that the media product was consumed by the user based on a user's response detected by sensors communicably coupled to computing device 120 or based on the user's interaction with the media product. For example, if the user is scrolling through a news feed including numerous news articles and the user slows down the speed of scrolling or stops scrolling for a certain amount of time while the news article is in display on user interface 122, then the one or more processors may determine that the user has consumed the news article by reading it or listening to an audio output of the news article. Further, the one or more processors may determine that the user has consumed the news article if the user clicks on a user selectable icon displayed on user interface 122 that corresponds to the news article, wherein the user selectable icon may correspond to user feedback (e.g., like, comment, etc.) or user action (e.g., share, save, repost, etc.) to the news article.

Responsive to determining 130 that the media product was presented via user interface, the one or more processors may be configured to present 132 a question about the media product via user interface 122. For example, the one or more processors may be configured to perform a search for related media products using the title of the media product as an input to the search query. Further, the one or more processors may be configured to generate output data corresponding to search results including a list of the related media products determined based on the title of the media product. For example, if the media product is a news article having a title “COVID-19 is not a real threat”, then the one or more processors may be configured to perform a search using the title to generate a list of related news articles to that title. Further, the one or more processors may be configured to process the list of related news articles to generate a question about the COVID-19 news article and an answer to the question. The one or more processors may be further configured to present 132 the question about the media product (e.g., COVID-19 news article) via user interface 122. Further, the one or more processors may be configured to present 134 the answer to the question via user interface 122. The specifics about how the question and answer are determined will be described below.

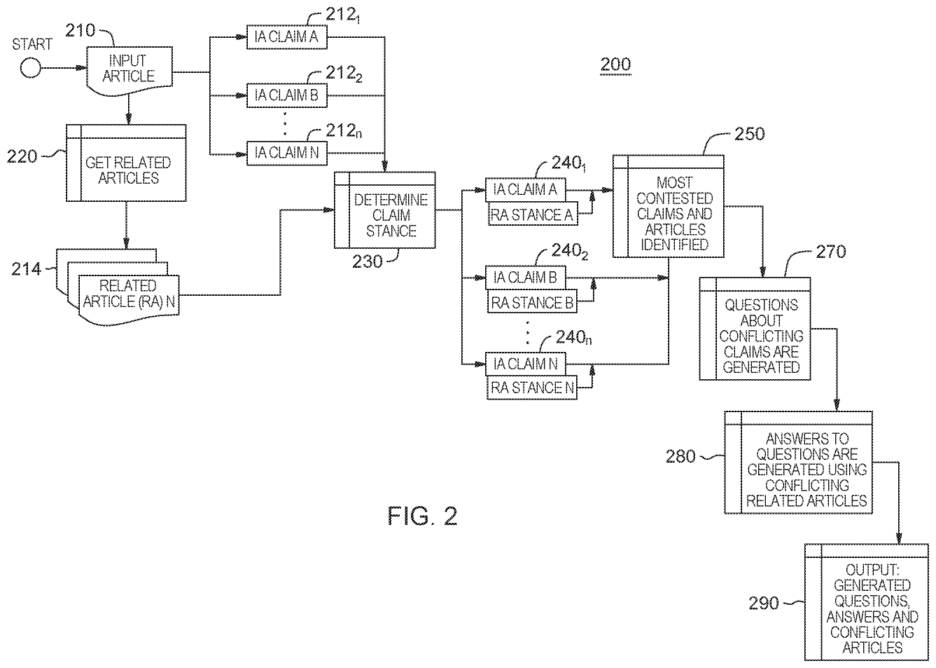

FIG. 2 depicts a block diagram of a computer-implemented process 200 for presenting thought-provoking information about a media product, in accordance with an embodiment of the present invention.

In an embodiment, process 200 starts with input article 210 being determined, by one or more processors, to have been consumed (e.g., read or listened to) by a user via a user interface of a computing device. A title of input article 210 may be determined by searching input article 210 for text corresponding to the title. Once a title is determined, the one or more processors may be configured to search for related articles and get 220 related articles 214 for further processing.

In an embodiment, process 200 may include one or more processors configured for determining one or more claims 212₁₋ₙ for input article (“IA”) 210 (e.g., IA claim A, IA claim B, IA claim N). Further, process 200 may include one or more processors configured for determining one or more related claims for a related article. The one or more claims 212₁₋ₙ for input article may be determined using a machine learning model. The machine learning model may include a binary classifier. The one or more processors may be configured for training the binary classifier using a first labeled data set. Once the binary classifier is trained, the one or more processors of the binary classifier may be configured for processing input article 210 and outputting one or more claims 212₁₋ₙ for input article 210.

In an embodiment, process 200 may include one or more processors configured to determine 230 one or more related article (RA) stances 240₁₋ₙ (e.g., positions) based, at least in part, on one or more claims 212₁₋ₙ for input article 210 and one or more related articles 214. A related article stance 240 (e.g., position) may be determined for each related article 214 with respect to each claim 212₁₋ₙ for input article 210. The claim stance may be determined by first training a machine learning algorithm to classify each related article 214 as one of various positions corresponding to “agree”, “disagree”, “neutral”, or “unrelated” with respect to each claim. In other words, the trained machine learning algorithm may be configured to determine whether each related article 214 either agrees, disagrees, is neutral, or is unrelated to each claim of input article 210. For example, given a claim sentence “wearing masks does not prevent the spread of COVID-19”, a related article that contains sentences such as “if two individuals are wearing masks, the chance to spread COVID-19 is reduced by 99%”, can be classified as having a “disagree” stance or position with respect to the claim sentence.

In an embodiment, process 200 may include one or more processors configured to identify 250 most contested claims and corresponding conflicting articles based, at least in part, on the claim stances 240₁₋ₙ of related articles 214 for each claim and/or each claim's corresponding article sources. The most contested claims may be identified by determining which claims from input article 210 have the most related articles with a “disagree” stance. For example, if input article 210 has two (2) claims (e.g. IA claim A 212₁ and IA claim B 212₂) and the total number of related articles 214 is one hundred (100), and if IA claim A 212₁ has 90 related articles that “disagree” with input article 210 and IA claim B 212₂ has only 10 related articles that “disagree” with input article 210, then IA claim A 212₁ would be determined as the most contested claim. In this example, since 90 related articles with a disagree stance is greater than 10 related articles with a disagree stance, the claim with the most disagrees is the most contested claim. A predetermined threshold may be established that must be met to classify a claim as a most contested claim relative to other claims in the input article 210. Here, the predetermined threshold is just that the number of disagrees must be greater for one claim compared to another. Thus, the condition is satisfied corresponding to having a predetermined number of the related articles in disagreement with the input claim. In the case of a tie, other factors may be considered to perform a tiebreaker or both articles with the most but also equal number of disagree stances may be identified as the most contested claims.

In an embodiment, process 200 may include one or more processors configured to generate 270 at least one question based on the most contested claim or based on the most contested claim and a paragraph including the most contested claim. For example, a portion of text of any length may be provided as input data to a bidirectional sequence to sequence long short-term memory (LSTM) model to generate a question. As another example, an input sentence could be “5G radiation causes COVID-19 symptoms”, wherein the LSTM model may be configured to learn to output a question that says, “What causes COVID-19 symptoms?”. Other embodiments of this example may not require machine learning algorithms but may utilize specific rules.

In an embodiment, process 200 may include one or more processors configured to generate 280 answers to questions using conflicting related articles. For example, the question that was generated in response to the most contested claim and a related article that disagrees with the most contested claim may be used together to extract evidence from the passage of the related article that disagrees with the most contested claim. The extracted evidence (e.g., evidence snippets) may then be encoded with the question and the related article that disagrees with the most contested claim to generate a latent variable. A neural network may then be configured to learn to decode the latent variable to generate an answer to the question. For example, if the question is “What causes COVID-19 symptoms?”, and the related article that disagrees with the most contested claim contains the text “The COVID-19 virus causes people to experience flu-like symptoms”, then the neural network may be configured to learn the output “The COVID-19 virus” as an answer to the question.

In an embodiment, process 200 may include one or more processors configured to output 290 the generated questions, the answers and the conflicting related articles to a user interface of a computing device associated with a user. Further, the question and the answer may be presented via the user interface during a time frame to allow a user to perceive the question along with the answer.

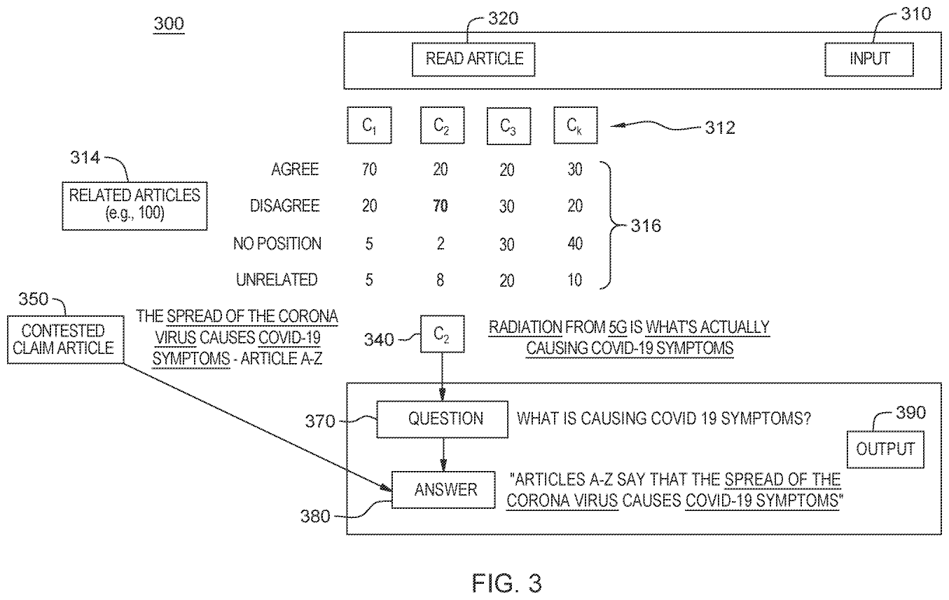

FIG. 3 depicts an example chart 300 for presenting thought-provoking information about a media product, in accordance with an embodiment of the present invention.

In an embodiment, one or more processors may be configured to receive input data 310 corresponding to an indication that a media product (e.g., article) was read by a user. The one or more processors may be configured to determine that the media product was read by the user based on a user's response detected by sensors communicably coupled to computing device 120 or based on the user's interaction with the article. For example, if the user is scrolling through a news feed including numerous media products (e.g., news articles) and the user slows down the speed of scrolling or stops scrolling for a certain amount of time while a media product is in display on user interface 122, then the one or more processors may determine that the user has consumed the media product by reading it or listening to an audio output of the article. Further, the one or more processors may determine that the user has read the media product if the user clicks on a user selectable icon displayed on user interface 122 that corresponds to the media product, wherein the user selectable icon may correspond to user feedback (e.g., like, comment, etc.) or user action (e.g., share, save, repost, etc.) to the media product.

In an embodiment, one or more processors may be configured to identify related articles (e.g., 100) by performing a search of a title of the media product in a database of media products (e.g., news articles).

In an embodiment, the one or more processors may be configured for determining one or more claims 312 (e.g., C₁, C₂, C₃, Cₖ) for the media product. The one or more claims 312 (e.g., C₁, C₂, C₃, Cₖ) for the media product may be determined using a machine learning model (e.g., a binary classifier) configured for training the binary classifier and processing the media product to output ranked sets of sentences containing one or more claims 312 (e.g., C₁, C₂, C₃, Cₖ) for the media product.

As shown in chart 300, an embodiment of the described invention may include one or more processors configured for determining a relationship 316 between the one or more claims 312 (e.g., C₁, C₂, C₃, Cₖ) for the read media product (e.g., read article 320) and the related articles 314. For example, a relationship 316 may include a position or stance where a related article 314 either agrees, disagrees, has no position, or is unrelated to one of the one or more claims 312 (e.g., C₁, C₂, C₃, Cₖ).

In an embodiment, most contested claim 340 may be determined as a claim that is identified as having a relationship 316 with the most related articles that disagree with the claim. For example, claim C₂ of the one or more claims 312 has a quantity of 70 disagreeing related articles 314. Therefore, the most contested claim 340 may be identified as claim C₂ because that claim has 70 instances of related articles that are in disagreement with claim C₂.

In an embodiment, the most contested claim 340 of the media product may include the following text, “Radiation from 5G is what's actually causing COVID-19 symptoms”, wherein the one or more processors may be configured to identify related articles 314 that disagree with most contested claim 340. For example, in chart 300, the most contested claim 340 is identified as claim C₂, which states “Radiation from 5G is what's actually causing COVID-19 symptoms”, and the related article has the stance of which is identified as being mostly in disagreement with claim C₂ may state, “The spread of the corona virus causes COVID-19 symptoms”. With this information, one or more processors may be configured to use the most contested claim 340 to generate a question (e.g., “What is causing COVID-19 symptoms?”), wherein the one or more processors may be configured to then provide the generated question and one or more of the related articles 314 that disagree with C₂ as input data to the one or more processors (e.g., an answer generation algorithm) to generate output data corresponding to an answer (e.g., “Articles A-Z say that the spread of the COVID-19 virus causes COVID-19 symptoms.”) to the question.

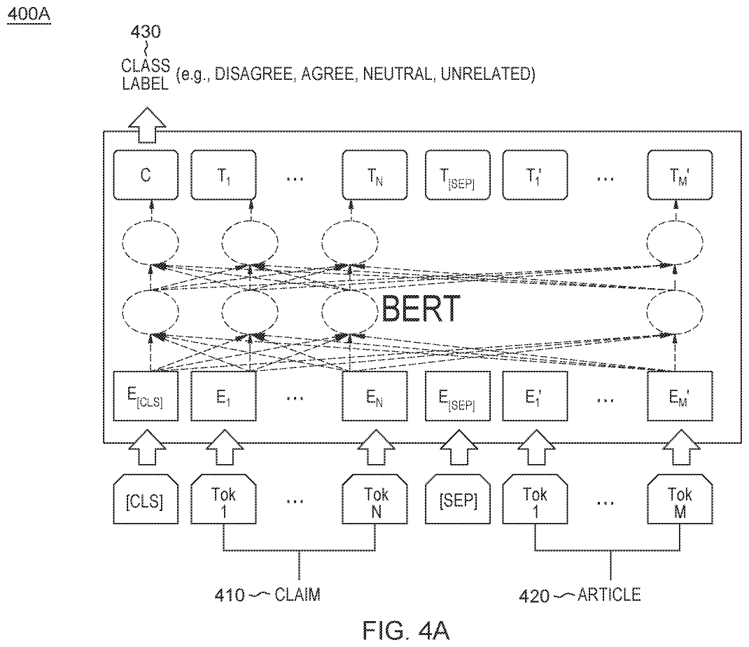

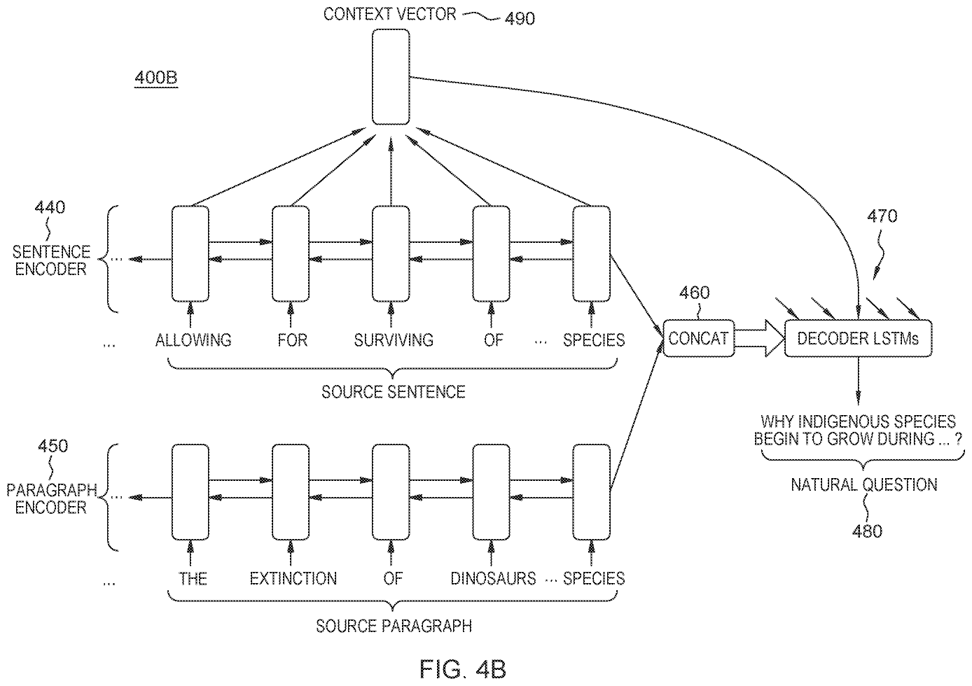

In an embodiment, the one or more processors may be configured for generating a question 370 based at least on the most contested claim 340. Question 370 may also be generated based on a paragraph (not shown) that contains text from input data 310 corresponding to the media product that provides more context compared to just providing the sentence including the most contested claim 340. For example, question 370 may include the text, “What is causing COVID-19 symptoms?”. In an embodiment, generating the question may further include processing, at a third machine learning model, as further described in FIG. 4, the most contested claim 340 and the paragraph including the most contested claim 340 using bidirectional LSTM to generate a question.

In an embodiment, the one or more processors may be configured for generating an answer 380 to the question 370. For example, the answer 380 to the question 370 may include the text, “Articles A-Z say that the spread of the corona virus causes COVID-19 symptoms.” In an embodiment, the one or more processors may be configured for generating the answer 380 to the question 370 based at least on the question 370 and at least one of articles (e.g., Contested Claim Article 350) that disagrees with the most contested claim.

In an embodiment, generating the answer may further include processing, at a fourth machine learning model, the question 370 and the related media product (e.g., shown as Contested Claim Article 350 in FIG. 3) that disagrees with the most contested claim 340 to extract evidence snippets using a bidirectional recurrent neural network (RNN); and processing, by the fourth machine learning model, the evidence snippets, the question 370, and at least one of the mostly disagreeing articles (e.g. Contested Claim Article 350) that disagrees with the most contested claim to generate answer data corresponding to the answer.

In an embodiment, the one or more processors may be configured to output 390 the question 370 and the answer 380 to the question corresponding to the most contested claim 340.

While the foregoing describes implementation of a machine learning model, the present disclosure is not limited thereto. In at least some embodiments, machine learning model may implement a trained component or trained model configured to perform the processes described above. The trained component may include one or more machine learning models, including but not limited to, one or more classifiers, one or more neural networks, one or more probabilistic graphs, one or more decision trees, and others. In other embodiments, the trained component may include a rules-based engine, one or more statistical-based algorithms, one or more mapping functions or other types of functions/algorithms to determine whether a natural language input is a complex or non-complex natural language input. In some embodiments, the trained component may be configured to perform binary classification, where the natural language input may be classified into one of two classes/categories. In some embodiments, the trained component may be configured to perform multiclass or multinomial classification, where the natural language input may be classified into one of three or more classes/categories. In some embodiments, the trained component may be configured to perform multi-label classification, where the natural language input may be associated with more than one class/category.

Various machine learning techniques may be used to train and operate trained components to perform various processes described herein. Models may be trained and operated according to various machine learning techniques. Such techniques may include, for example, neural networks (such as deep neural networks and/or recurrent neural networks), inference engines, trained classifiers, etc. Examples of trained classifiers include Support Vector Machines (SVMs), neural networks, decision trees, AdaBoost (short for “Adaptive Boosting”) combined with decision trees, and random forests. Focusing on SVM as an example, SVM is a supervised learning model with associated learning algorithms that analyze data and recognize patterns in the data, and which are commonly used for classification and regression analysis. Given a set of training examples, each marked as belonging to one of two categories, an SVM training algorithm builds a model that assigns new examples into one category or the other, making it a non-probabilistic binary linear classifier. More complex SVM models may be built with the training set identifying more than two categories, with the SVM determining which category is most similar to input data. An SVM model may be mapped so that the examples of the separate categories are divided by clear gaps. New examples are then mapped into that same space and predicted to belong to a category based on which side of the gaps they fall on. Classifiers may issue a “score” indicating which category the data most closely matches. The score may provide an indication of how closely the data matches the category.

In order to apply the machine learning techniques, the machine learning processes themselves need to be trained. Training a machine learning component requires establishing a “ground truth” for the training examples. In machine learning, the term “ground truth” refers to the accuracy of a training set's classification for supervised learning techniques. Various techniques may be used to train the models including backpropagation, statistical learning, supervised learning, semi-supervised learning, stochastic learning, or other known techniques.

FIG. 4A depicts a block diagram of machine learning model 400A for classifying a position (e.g., class label 430) of a related media product (e.g., article 420), in accordance with an embodiment of the present invention. In an embodiment, a machine learning model may include a process for training model 400A to determine the stance or position (e.g., class label 430) of a related media product with respect to each of the one or more claims (e.g., claim 410) from the input media product (e.g., article 420). For example, one or more processors may be configured for providing claim 410 and related media product (e.g., article 420) pair as inputs and generating stance predictions or class label 430 (i.e., if the article agrees, disagrees, takes no position, or is unrelated to the claim) as outputs. The one or more processors may be configured to aggregate the stance or class label 430 of related media products (e.g., related articles) for each claim 410 of the input related media product (e.g., article 420) and to determine the most contested claims. For example, a claim is more contested when there are more articles that disagree with it. For example, model 400A may include a pre-trained deep bidirectional transformer language model (e.g., BERT) configured to be fine-tuned with a data set including articles, claims, and the stance the article takes on the claim. Further, model 400A may be configured to learn general patterns of language from a large corpus of text, and then may be configured to be fine-tuned for a specific task, such as stance classification or stance position.

FIG. 4B depicts another block diagram of machine learning model 400B for generating a question, in accordance with an embodiment of the present invention. In an embodiment, model 400B may include sentence encoder 440 configured to receive a source sentence and encode words or phrases in the source sentence to generate sentence vectors corresponding to features of the words or phrases. Sentence encoder 440 may be configured to receive data corresponding to a sentence of a claim. Model 400B may also include paragraph encoder 450 configured to receive a source paragraph and encode words, phrases, or sentences to generate paragraph vectors corresponding to features of the words, phrases, or sentences. Further, model 400B may include one or more processors configured to concatenate 460 the sentence vectors and the paragraph vectors as input data to be provided to LSTM decoder 470. The input data sources may be configured to provide context for what information should be generated in the question, which allows for the LSTM decoder to generate a question 480 that is specific to the contested claim, which would be the source sentence described above, and the paragraph that includes the contested claim may be provided as input data to the paragraph encoder described above.

In an embodiment, attention-based encoders may be configured to use bidirectional LSTM to encode the claim and the paragraph. Further, the one or more processors may be configured to concatenate 460 the claim and paragraph encoding as inputs to LSTM decoder 470, which generates output data corresponding to a question 480 based on the sentence provided as the input. For example, the source sentence may include the text, “allowing for surviving . . . species”, and the source paragraph may include the text, “the extinction of dinosaurs . . . species”, and both the source sentence and source paragraph may be concatenated as input data to LSTM decoder 470 along with context vector 490 data to generate natural question 480 as output data, wherein natural question 480 may include the text, “Why indigenous species begin to grow during . . . ?” Context vector 490 may correspond to the sum of the weighted average of the source sentence encoder hidden states. In other embodiments, context vector 490 may be a weighted average of the sentence encoder hidden states and can be some combination of sentence and paragraph encoders focusing on the specific part of the sentence/paragraph that is the subject of focus of the claim (i.e., context focuses on the sentence including the most contested claim). In an embodiment, model 400B may use the Stanford Question Answering Dataset (SQuAD) in performing the encoding and decoding processes described herein. The context vector, source paragraph, and source sentence may be used as input data to generate question 480, which may allow for the LSTM decoder to create question 480 that is specific to the contested claim, i.e., the source sentence described above, and the paragraph that includes the contested claim would be provided as input data to the paragraph encoder described above.

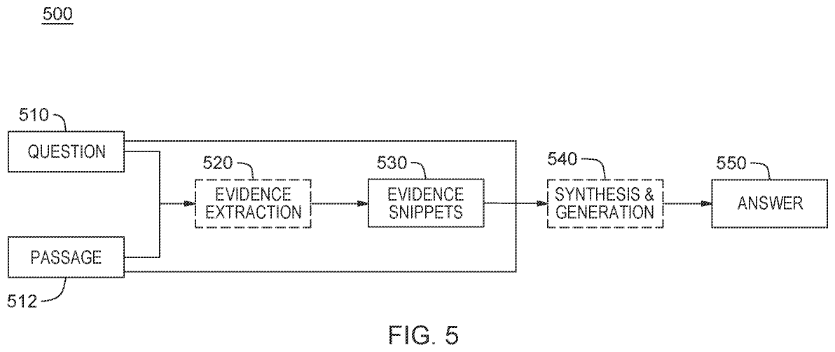

FIG. 5 depicts a block diagram of recurrent neural network (RNN) model 500 for presenting thought-provoking information about a media product, in accordance with an embodiment of the present invention. In an embodiment, model 500 may be configured for generating an answer to the question as described above herein. For example, model 500 may be configured to receive question 510 data corresponding to an input article's contested claim and passage 512 data corresponding to related conflicting articles as input data to model 500 and perform evidence extraction 520 on the input data to generate evidence snippets 530. Evidence snippets 530 and input data (i.e., 510, 512) may be processed using synthesis and generation 540 to generate output data corresponding to an answer 550. In an embodiment, passage 512 data may include text data from a related conflicting article or related disagreeing article.

In other words, model 500 may be configured to extract 520 evidence snippets 530 by using a bidirectional RNN to encode the question 510 and passage 512. Further, model 500 may be configured to match the question and the passage using an attention mechanism. Further, model 500 may be configured to predict a start and an end of the evidence snippets 530 using a pointer network. Furthermore, model 500 may be configured to generate answer 550 by encoding and decoding the question 510, passage 512, and evidence snippets 530. In an embodiment, model 500 may be configured to use the Microsoft Machine Reading Comprehension (MS-MARCO) dataset to execute the processes described herein.

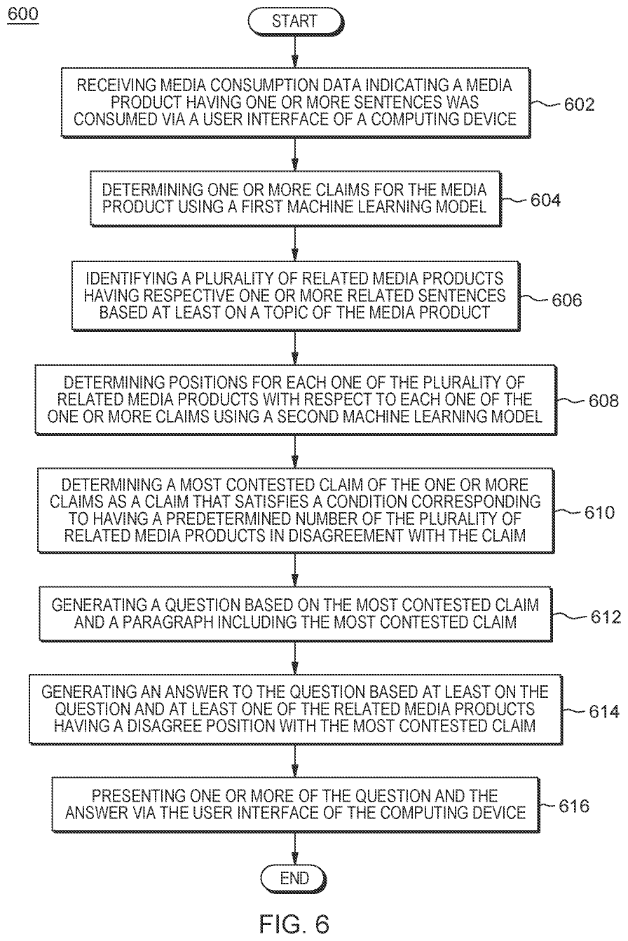

FIG. 6 depicts a flow chart of steps of a computer-implemented method 600 for presenting thought-provoking information in response to misinformation, in accordance with an embodiment of the present invention.

In an embodiment, one or more processors may be configured for receiving 602 media consumption data indicating a media product (e.g., news article) having one or more sentences was consumed via a user interface of a computing device.

In an embodiment, one or more processors may be configured for determining 604 one or more claims for the media product using a first machine learning model, as described in FIG. 2. The first machine learning model may include a binary classifier and determining 604 the one or more claims may further include training the binary classifier using a first labeled data set; processing, by the binary classifier, the media product having one or more sentences; and outputting, by the binary classifier, ranked sets of sentences for the media product, wherein the ranked sets of sentences may correspond to the one or more sentences and are ranked based on a likelihood to contain the one or more claims.

In an embodiment, one or more processors may be configured for identifying 606 a plurality of related media products having respective one or more related sentences based at least on a topic of the media product. The topic of the media product may be determined by processing, using a trained classifier, the one or more sentences of the media product to identify text corresponding to the topic.

Identifying 606 the plurality of related media products may further include processing, by a media collection program, input data corresponding to the topic of the media product; and generating, by the media collection program, a list of the plurality of related media products in order of most related to least related, wherein the media collection program is configured to search a database of media products and return a list of related media products corresponding to the input data provided to the media collection program.

In an embodiment, the one or more processors may be configured for determining 608 positions for each one of the plurality of related media products with respect to each of the one or more claims for the media product using a second machine learning model, as described in FIG. 4A. The positions may correspond to one of a set of stances of whether the related article “agrees”, “disagrees”, “is neutral”, or is “unrelated” to the one or more claims of the media product. Thus, the positions may include the “disagree” position, an “agree” position, a “neutral” position, or an “unrelated” position, wherein the positions indicate a relationship between each one of the related articles to the one or more claims of the media product.

In an embodiment, one or more processors may be configured for determining 610 a most contested claim of the one or more claims as a claim that satisfies a condition corresponding to having a predetermined number of the plurality of related media products in disagreement with the claim, or mostly disagrees with the one or more claims of the media product. In an embodiment, determining 610 the most contested claim may further include processing, at the second machine learning model, the one or more claims and at least one of the plurality of related media products; outputting, by the second machine learning model, a position for each one of the plurality of related media products, wherein the position may correspond to a relationship between the one or more claims and each one of the plurality of related media products; and identifying the most contested claim as the claim of the one or more claims with a most negative relationship with the plurality of related media products. For example, the most contested claim is the claim that has the most related media products with a disagree stance (i.e., position).

In an embodiment, one or more processors may be configured for generating 612 a question based on the most contested claim and a paragraph including the most contested claim. In an embodiment, generating 612 the question may further include processing, at a third machine learning model, as described in FIG. 4B, the most contested claim and the paragraph including the most contested claim using a bidirectional long short term memory (LSTM) to generate LSTM encoder output data; concatenating, by the third machine learning model, the LSTM encoder output data to generate LSTM decoder input data; and processing, by the third machine learning model, the LSTM decoder input data and a context vector to generate question data corresponding to the question, wherein the context vector is the sum of a weighted average of encoder hidden states.

In an embodiment, one or more processors may be configured for generating 614 an answer to the question based at least on the question and at least one of the related media products having a disagree position with the most contested claim. In an embodiment, generating 614 the answer may further include processing, at a fourth machine learning model, as described in FIG. 3 and FIG. 5, the question and the related media product that disagrees with the most contested claim to extract evidence snippets using a bidirectional recurrent neural network (RNN); and processing, by the fourth machine learning model, the evidence snippets, the question and the related media product that disagrees with the most contested claim to generate answer data corresponding to the answer.

In an embodiment, one or more processors may be configured for presenting 616 one or more of the question and the answer via the user interface of the computing device. The question and the answer, as well as the conflicting related media product, may be presented via the user interface during a time frame to allow a user to perceive the question along with the answer.

FIG. 7 depicts a block diagram of components of computer 700, suitable for server 125 and/or user computing device 120 within distributed data processing environment 100 of FIG. 1, in accordance with an embodiment of the present invention. It should be appreciated that FIG. 7 provides only an illustration of one implementation and does not imply any limitations with regard to the environments in which different embodiments can be implemented. Many modifications to the depicted environment can be made.

Computer 700 includes communications fabric 702, which provides communications between cache 716, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses or a crossbar switch.

Memory 706 and persistent storage 708 are computer readable storage media. In this embodiment, memory 706 includes random access memory (RAM). In general, memory 706 can include any suitable volatile or non-volatile computer readable storage media. Cache 716 is a fast memory that enhances the performance of computer processor(s) 704 by holding recently accessed data, and data near accessed data, from memory 706.

Programs may be stored in persistent storage 708 and in memory 706 for execution and/or access by one or more of the respective computer processors 704 via cache 716. In an embodiment, persistent storage 708 includes a magnetic hard disk drive. Alternatively, or in addition to a magnetic hard disk drive, persistent storage 708 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 710, in these examples, provides for communications with other data processing systems or devices. In these examples, communications unit 710 includes one or more network interface cards. Communications unit 710 may provide communications through the use of either or both physical and wireless communications links. Programs, as described herein, may be downloaded to persistent storage 708 through communications unit 710.

I/O interface(s) 712 allows for input and output of data with other devices that may be connected to server 125 and/or computing device 120. For example, I/O interface 712 may provide a connection to external devices 718 such as an image sensor, a keyboard, a keypad, a touch screen, and/or some other suitable input device. External devices 718 can also include portable computer readable storage media such as, for example, thumb drives, portable optical or magnetic disks, and memory cards. Software and data 714 used to practice embodiments of the present invention can be stored on such portable computer readable storage media and can be loaded onto persistent storage 708 via I/O interface(s) 712. I/O interface(s) 712 also connect to display 720.

Display 720 provides a mechanism to display data to a user and may be, for example, a computer monitor.

Software and data 714 described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for presenting thought-provoking information about a media product, the computer-implemented method comprising:
receiving, by one or more processors, media consumption data indicating a media product having one or more sentences was consumed via a user interface of a computing device;
determining, by the one or more processors, one or more claims for the media product using a first machine learning model;
identifying, by the one or more processors, a plurality of related media products having respective one or more related sentences based at least on a topic of the media product;
determining, by the one or more processors, positions for each one of the plurality of related media products with respect to each of the one or more claims for the media product using a second machine learning model;
determining, by the one or more processors, a most contested claim of the one or more claims for the media product as a claim that satisfies a condition corresponding to having a predetermined number of the plurality of related media products in disagreement with the claim;
generating, by the one or more processors, a question based on the most contested claim and a paragraph of the media product including the most contested claim;
generating, by the one or more processors, an answer to the question based at least on the question and at least one of the related media products having a disagree position with the most contested claim; and
presenting, by the one or more processors, one or more of the question and the answer via the user interface of the computing device.

2. The computer-implemented method of claim 1, wherein the topic of the media product is determined by:
processing, using a trained classifier, the one or more sentences of the media product to identify text corresponding to a title of the media product; and
identifying, by the one or more processors, the title as the topic.

3. The computer-implemented method of claim 1, wherein identifying the plurality of related media products further comprises:
processing, by a media collection program, input data corresponding to the topic of the media product; and
generating, by the media collection program, a list of the plurality of related media products in order of most related to least related, wherein the media collection program is configured to search a database of media products and return a list of related media products corresponding to the input data provided to the media collection program.

4. The computer-implemented method of claim 1, wherein the first machine learning model is a binary classifier and determining the one or more claims further comprises:
training the binary classifier using a first labeled data set;
processing, by the binary classifier, the media product having the one or more sentences; and
outputting, by the binary classifier, ranked sets of sentences for the media product, wherein the ranked sets of sentences corresponds to the one or more sentences and are ranked based on a likelihood to contain the one or more claims.

5. The computer-implemented method of claim 1, wherein the positions comprise the disagree position, an agree position, a neutral position, and an unrelated position.

6. The computer-implemented method of claim 1, wherein determining the most contested claim further comprises:
processing, at the second machine learning model, the one or more claims and at least one of the plurality of related media products;
outputting, by the second machine learning model, a position for each one of the plurality of related media products, wherein the position corresponds to a relationship between the one or more claims and each one of the plurality of related media products; and
identifying, by the one or more processors, the most contested claim as the claim with a most negative relationship with the plurality of related media products.

7. The computer-implemented method of claim 1, wherein generating the question further comprises:
processing, at a third machine learning model, the most contested claim and the paragraph including the most contested claim using bidirectional long-short term memory (LSTM) to generate LSTM encoder output data;
concatenating, by the third machine learning model, the LSTM encoder output data to generate LSTM decoder input data; and
processing, by the third machine learning model, the LSTM decoder input data and a context vector to generate question data corresponding to the question, wherein the context vector is a sum of a weighted average of encoder hidden states.

8. The computer-implemented method of claim 1, wherein generating the answer further comprises:
processing, at a fourth machine learning model, the question and the related media product that disagrees with the most contested claim to extract evidence snippets using a bidirectional recurrent neural network (RNN); and
processing, by the fourth machine learning model, the evidence snippets, the question, and the related media product that disagrees with the most contested claim to generate answer data corresponding to the answer.

9. A computer program product for presenting thought-provoking information about a media product, the computer program product comprising:
one or more computer readable storage media and program instructions collectively stored on the one or more computer readable storage media, the stored program instructions comprising:
program instructions to receive media consumption data indicating a media product having one or more sentences was consumed via a user interface of a computing device; program instructions to determine one or more claims for the media product using a first machine learning model;
program instructions to identify a plurality of related media products having respective one or more related sentences based at least on a topic of the media product;
program instructions to determine positions for each one of the plurality of related media products with respect to each of the one or more claims for the media product using a second machine learning model;
program instructions to determine a most contested claim of the one or more claims for the media product as a claim that satisfies a condition corresponding to having a predetermined number of the plurality of related media products in disagreement with the claim;
program instructions to generate a question based on the most contested claim and a paragraph including the most contested claim;
program instructions to generate an answer to the question based at least on the question and at least one of the related media products having a disagree position with the most contested claim; and
program instructions to present one or more of the question and the answer via the user interface of the computing device.

10. The computer program product of claim 9, wherein the topic of the media product is determined by:
program instructions to process, using a trained classifier, the one or more sentences of the media product to identify text corresponding to a title; and
program instructions to identify the title as the topic.

11. The computer program product of claim 9, wherein the program instructions to identify the plurality of related media products further comprise:
program instructions to process, by a media collection program, input data corresponding to the topic of the media product; and
program instructions to generate, by the media collection program, a list of the plurality of media products in order of most related to least related, wherein the media collection program is configured to search a database of media products and return a list of related media products corresponding to the input data provided to the media collection program.

12. The computer program product of claim 9, wherein the first machine learning model is a binary classifier and determining the one or more claims further comprises:
program instructions to train the binary classifier using a first labeled data set;
program instructions to process, by the binary classifier, the media product having the one or more sentences; and
program instructions to output, by the binary classifier, ranked sets of sentences for the media product, wherein the ranked sets of sentences corresponds to the one or more sentences and are ranked based on a likelihood to contain the one or more claims.

13. The computer program product of claim 9, wherein the positions comprise the disagree position, an agree position, a neutral position, and an unrelated position.

14. The computer program product of claim 9, wherein the program instructions to determine the most contested claim further comprise:
program instructions to process, at the second machine learning model, the one or more claims and at least one of the plurality of related media products;
program instructions to output, by the second machine learning model, a position for each one of the plurality of related media products, wherein the position corresponds to a relationship between the one or more claims and each one of the plurality of related media products; and
program instructions to identify, by the one or more processors, the most contested claim as the claim with a most negative relationship with the plurality of related media products.

15. The computer program product of claim 9, wherein the program instructions to generate the question further comprise:
program instructions to process, at a third machine learning model, the most contested claim and the paragraph including the most contested claim using bidirectional long-short term memory (LSTM) to generate LSTM encoder output data;
program instructions to concatenate, by the third machine learning model, the LSTM encoder output data to generate LSTM decoder input data; and
program instructions to process, by the third machine learning model, the LSTM decoder input data and a context vector to generate question data corresponding to the question, wherein the context vector is a sum of a weighted average of encoder hidden states.

16. The computer program product of claim 9, wherein the program instructions to generate the answer further comprises:
program instructions to process, at a fourth machine learning model, the question and the related media product that disagrees with the most contested claim to extract evidence snippets using a bidirectional recurrent neural network (RNN); and
program instructions to process, by the fourth machine learning model, the evidence snippets, the question and the related media product that disagrees with the most contested claim to generate answer data corresponding to the answer.

17. A computer system for presenting thought-provoking information about a media product, the computer system comprising:
one or more computer processors;
one or more computer readable storage media;
program instructions collectively stored on the one or more computer readable storage media for execution by at least one of the one or more computer processors, the stored program instructions comprising:
program instructions to receive media consumption data indicating a media product having one or more sentences was consumed via a user interface of a computing device;
program instructions to determine one or more claims for the media product using a first machine learning model;
program instructions to identify a plurality of related media products having respective one or more related sentences based at least on a topic of the media product;
program instructions to determine positions for each one of the plurality of related media products with respect to each of the one or more claims for the media product using a second machine learning model;
program instructions to determine a most contested claim of the one or more claims for the media product as a claim that satisfies a condition corresponding to having a predetermined number of the plurality of related media products in disagreement with the claim;
program instructions to generate a question based on the most contested claim and a paragraph including the most contested claim;
program instructions to generate an answer to the question based at least on the question and at least one of the related media products having a disagree position with the most contested claim; and
program instructions to present one or more of the question and the answer via the user interface of the computing device.

18. The computer system of claim 17, wherein the topic of the media product is determined by:
program instructions to process, using a trained classifier, the one or more sentences of the media product to identify text corresponding to a title; and
program instructions to identify the title as the topic.

19. The computer system of claim 17, wherein the program instructions to identify the plurality of related media products further comprises:
program instructions to process, by a media collection program, input data corresponding to the topic of the media product; and
program instructions to generate, by the media collection program, a list of the plurality of media products in order of most related to least related, wherein the media collection program is configured to search a database of media products and return a list of related media products corresponding to the input data provided to the media collection program.

20. The computer system of claim 17, wherein the first machine learning model is a binary classifier and the program instructions to determine the one or more claims further comprise:
program instructions to train the binary classifier using a first labeled data set;
program instructions to process, by the binary classifier, the media product having the one or more sentences; and
program instructions to output, by the binary classifier, ranked sets of sentences for the media product, wherein the ranked sets of sentences correspond to the one or more sentences and are ranked based on a likelihood to contain the one or more claims.

21. The computer system of claim 17, wherein the positions comprise the disagree position, an agree position, a neutral position, and an unrelated position.

22. The computer system of claim 17, wherein the program instructions to determine the most contested claim further comprise:
program instructions to process, at the second machine learning model, the one or more claims and at least one of the plurality of related media products;
program instructions to output, by the second machine learning model, a position for each one of the plurality of related media products, wherein the position corresponds to a relationship between the one or more claims and each one of the plurality of related media products; and
program instructions to identify, by the one or more processors, the most contested claim as the claim with a most negative relationship with the plurality of related media products.

23. The computer system of claim 17, wherein the program instructions to generate the question further comprise:
program instructions to process, at a third machine learning model, the most contested claim and the paragraph including the most contested claim using bidirectional long-short term memory (LSTM) to generate LSTM encoder output data;
program instructions to concatenate, by the third machine learning model, the LSTM encoder output data to generate LSTM decoder input data; and
program instructions to process, by the third machine learning model, the LSTM decoder input data and a context vector to generate question data corresponding to the question, wherein the context vector is a sum of a weighted average of encoder hidden states.

24. The computer system of claim 17, wherein the program instructions to generate the answer further comprise:
program instructions to process, at a fourth machine learning model, the question and the related media product that disagrees with the most contested claim to extract evidence snippets using a bidirectional recurrent neural network (RNN); and
program instructions to process, by the fourth machine learning model, the evidence snippets, the question and the related media product that disagrees with the most contested claim to generate answer data corresponding to the answer.

25. The computer system of claim 17, wherein the question and the answer are presented via the user interface during a pre-set time frame to allow a user to perceive the question along with the answer.
